(19) United States
(12) Patent Application Publication
(10) Pub. No.: US 2015/0107938 A1
(43) Pub. Date: Apr. 23, 2015

(54) Lubricating Device and Operation Method

(71) Applicant: COBRRA s.r.o., Kosice (SK)

(72) Inventor: Peter CERVENKA, Povazska Bystrica (SK)

(21) Appl. No.: 14/487,477

(22) Filed: Sep. 16, 2014

(30) Foreign Application Priority Data
Oct. 17, 2013 (SK) 189-2013

(51) Int. Cl. B62J 31/00

(52) U.S. Cl. CPC B62J 31/00
USPC 184/55.1

(57) ABSTRACT

There is noticed a lubricating device and the operation method intended for compression lubricating which is consisting of a lid (1) with a lid air chamber (11), which is demountably attached to a casing (2) with the upper casing drain (21) with a sealing ring (12) and next with the lower casing drain (22) with a lock ring (23) and next with the casing oil chamber (24) with lubrication oil (5), which is demountably attached onto the lower cap (3) with a cap drain (32) with cap sealing ring (33) and next with one cap opening (34), to which a hose connection (41) with an outlet oil hose (4) is demountably attached and next with hollow cylinder (31) an oil chamber (35) with flow openings (311).

### TECHNICAL FIELD

The technical solution concerns a lubricating device and the operation method, intended for compression lubricating of a chain, particularly of motorcycles, quadricycles and transport vehicles utilising a chain drive.

### TECHNICAL BACKGROUND

To this date, manual methods for the motorcycle chain lubricating using lubricants after lifting a rear wheel of a motorcycle or while moving slowly on the road have been known. The disadvantage of this lubricating solution is major difficulty, and it is time consuming, by which not only the hands of the operator, but also the motorcycle itself become stained.

Another known solution is the motorcycle chain lubricating using an oil dispenser, which transports oil by gravity from the storage tank through a hose up to the intended lubricating point. The disadvantage of this solution is not only the lengthy dripping out of oil even during the inactive state of a motorcycle, irregular lubricating of the whole chain, but also the possibility of its leaking onto the ground even after putting the motorcycle into the rest condition.

Another known solution is the motorcycle chain lubricating by automatic oil dosage in drops in multi-minute periods depending on the engine run, speed and air temperature. The disadvantage of this solution is insufficient chain lubricating while raining, after the end of rain, in dusty environment, after a speedy ride, after riding of the particular amount of kilometres and slow chain lubricating resulting in its excessive wear.

Another known solution is described in the European patent file EP no.1 521 712 entitled Lubricating Device for Moving Parts of Lubricating Points, as for a line, where the lubricant dispenser and leading device of the line determine a leading duct of the lubricant in the longitudinal direction of the movement of the lubricated point, where in the lubricant dispenser, there are modified ducts used for lubricant feed from the lubricant pump into the lubricated point. The disadvantage of this solution is high price and complicated implementation for the chain drive.

Another known solution is described in the European patent file EP no.1 857 222 entitled Lubricating Device for Lubrication of Parts Sliding on each other and Rolling Parts of Machining Device, where there is a distributor fixed to the storage tank with a tube distribution of the lubricant substance to the lubricated points, where the movement of a spindle by the contact of ram face on the sliding part triggers lubricating. The disadvantage of this solution is complicated implementation for the chain drive.

Another known solution is described in the European patent file EP no. 2 125 491 entitled Lubricating System for Orthogonal Drives Used in Commercial Vehicles, where a shaft is fixed on an oil slinger, which inlets oil through the first flow duct to the first bearing and the pinion shaft with the second flow duct also inlets oil to a bearing. The disadvantage of this solution is complicated implementation for the chain drive.

Another known technical solution is described in the Czech utility model registered under no. 21 848 entitled Lubricating Device for Saw Chain of Hand Held Chainsaws with Hydraulic Drive, where a piston hydraulic pump is connected through the connecting duct to a hydraulic distribution of the saw operational medium, which flows into a hydraulic cylinder above the piston, under which the feed of the lubricating medium is performed, and the piston hydraulic pump is engaged into the opening of the lubricating medium tank, and by the pressure of hydraulic liquid on the piston, the lubricating medium is forced out through a hose into the lubricating area of a saw chain. The disadvantage of this technical solution is constructional complexity and high price.

### SUMMARY OF THE INVENTION

The presented insufficiencies are to a certain extent removed by a lubricating device intended for compression lubrication of a chain, according to this technical solution, whose basis relies on the fact that it consists of a lid with a lid air chamber, which is demountably attached onto the casing and/or attached via a lid sealing ring on the upper casing drain of casing, which is demountably attached onto a hollow cylinder with at least one flow opening, which is firmly attached onto the lower cap with the cap drain and with at least one cap opening, on which a hose connection with outlet oil hose is demountably attached, where the cap drain is attached onto the casing via the cap sealing ring.

Advantageously, there is a lower casing drain formed in the casing, in which there is a lock ring placed demountably.

Furthermore advantageously, the interior part of the hollow cylinder with flow openings and the upper part of the lower cap constitute an oil chamber with lubrication oil and the exterior part of the hollow cylinder with flow openings, the upper part of the lower cap and the interior part of the casing constitute a casing oil chamber with lubrication oil.

The presented insufficiencies are further removed to a certain extent by the operation method of the lubricating device intended for compression lubrication of a chain according to this technical solution, whose basis relies on the fact that by engaging of the lower cap into the casing and by the effect of compression air pressure in the lid air chamber, the lubrication oil is forced out of the oil chamber and of the casing oil chamber through flow openings and through cap opening into the oil hose.

### BRIEF DESCRIPTION OF DRAWINGS

FIG. 1 is the lubricating device illustrated without lubrication oil;

FIG. 2 is the lubricating device illustrated with lubrication oil.

### Preferred Embodiments of the Invention

### Embodiment No. 1

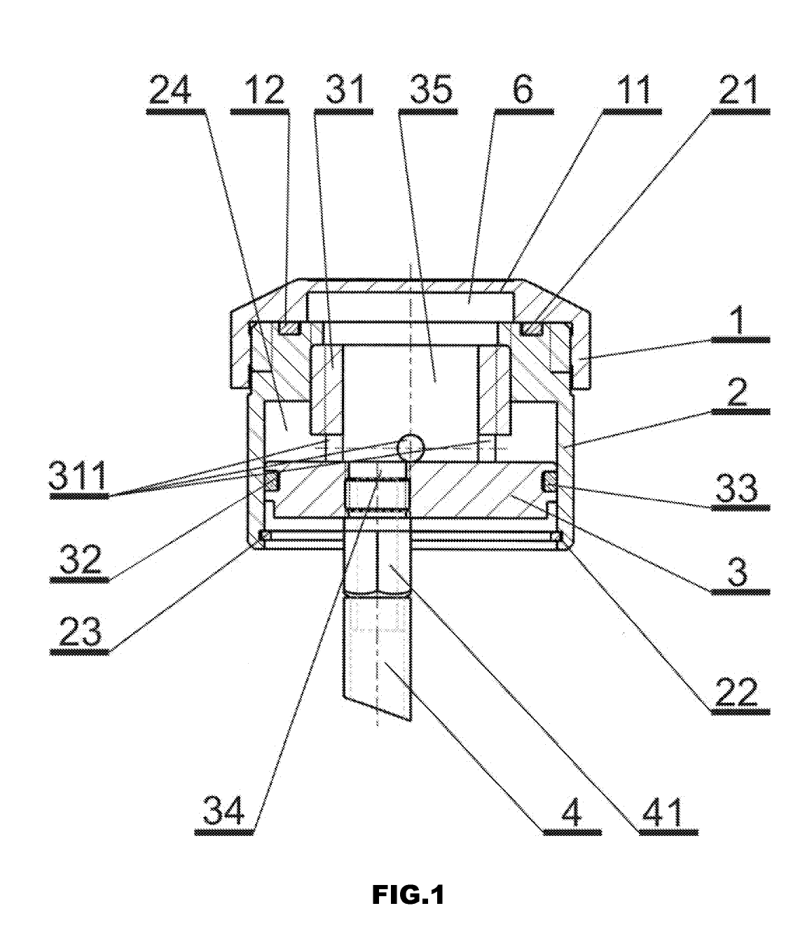

The lubricating device intended for the compression lubrication of a chain according to FIG. 1 consists of a lid 1. In the interior part of the lid 1, a lid air chamber 11 is formed, which is intended to retain air 6 for compression. On the interior side part of the lid 1, there is an exterior part of casing 2 demountably attached by a screw joint. On the upper part of the casing 2, the upper casing drain 21 is formed. In the upper casing drain 21, a lid sealing ring 12 is placed. The upper part of the casing 2 is fixed via the lid sealing ring 12 onto the lower part of the lid 1, which ensures air tightness 6. Into the upper casing part 2, there is an exterior part of a hollow cylinder 31 demountably attached by a screw joint, which has the same direction of the helix as the screw joint between the casing 2 and the lid 1. Onto the lower interior casing part 2, the lower cap 3 is slidably attached. Onto the upper part of the lower cap 3, the hollow cylinder 31 is firmly attached. The interior part of the hollow cylinder 31 and the upper part of the lower cap 3 comprise an oil chamber 35, which is intended for filling and forcing out the lubrication oil 5. In the lower part of the hollow cylinder 31, according to picture no.2, four flow openings 311 are formed, intended for the flow of the lubrication oil 5 from the oil chamber 35 into the casing oil chamber 24 and back. The casing oil chamber 24 consists of the exterior part of the hollow cylinder 31 with flow openings 311 and the upper part of the lower cap 3 and the interior side of the casing 2. In the lower part of the casing 2, a lower casing drain 22 is formed. In the lower casing drain 22, a lock ring 23 is placed demountably, which prevents the casing 2 from detaching from the lower cap 3. In the side part of the lower cap 3, a cap drain 32 is formed. In the cap drain 32, a cap sealing ring 33 is placed. The side part of the lower cap 3 is slidably attached via the cap sealing ring 33 onto the interior part of the casing 2, which ensures tightness of the casing oil chamber 24. In the lower cap 3, a cap opening 34 is formed, which is intended to discharge the lubrication oil 5 from the oil chamber 35. The hose connection 41 with the outlet oil hose 4, which are intended for compression flow of lubrication oil 5 to the point of lubrication, are demountably attached onto the cap opening 34.

### Embodiment No. 2

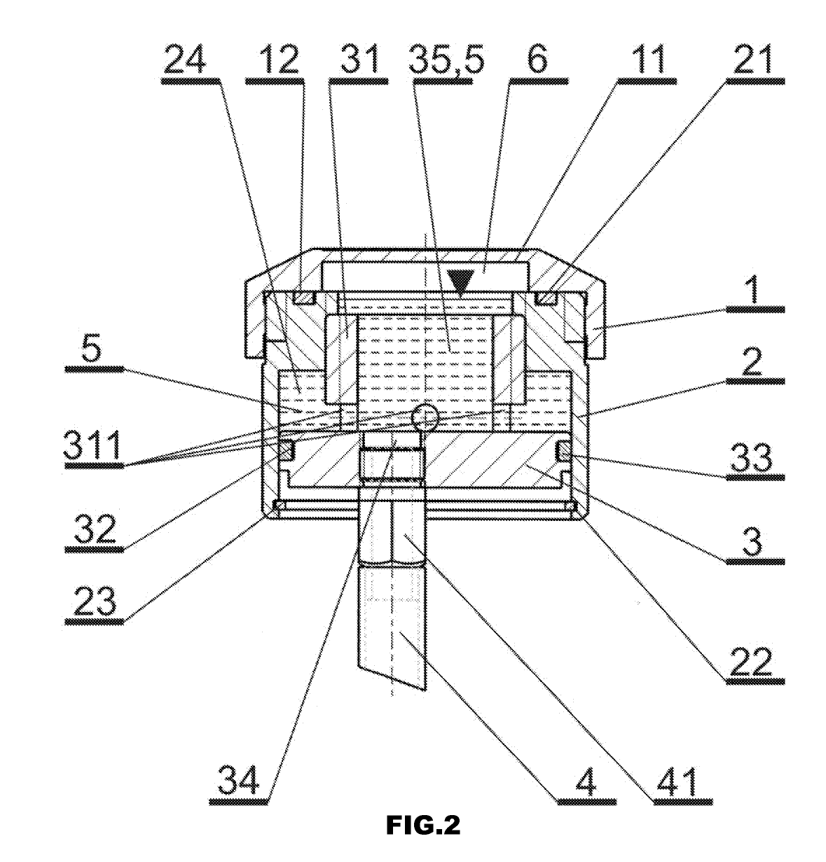

The operation method of the lubricating device intended for the compression lubricating of a chain, according to the FIG. 2, relies on the fact that first, the lid 1 is unscrewed from the casing 2. Then the lubrication oil 5, according to picture no.2, is filled into the oil chamber 35. The lubrication oil 5 then overflows from the oil chamber 35 through flow openings 311 into the casing oil chamber 24. Next, the lid 1 is screwed back onto the casing 2. By engaging of the lower cap 3 into the casing 2, compression air pressure 6 is created from the lid air chamber 11 onto the lubrication oil 5. Subsequently, the lubrication oil 5 is forced out of the oil chamber 35 through the cap opening 34 and through the outlet oil hose 4 with the hose connection 41 to the point of lubrication. Concurrently, the lubrication oil 5 is forced out of the casing oil chamber 24 through flow openings 311 into the oil chamber 35. After the complete engaging of the lower cap 3 into the casing 2, the lid 1 is unscrewed and the oil chamber 35 is again filled with the lubrication oil 5. By return disengagement of the lower cap 3 from the casing 2, part of the added lubrication oil 5 is overflown back from the oil chamber 35 through flow openings 311 into casing oil chamber 24, so that the level of the lubrication oil 5 is above the position of the flow openings 311.

After refilling of further amount of lubrication oil 5 into the oil chamber 35 and screwing of the lid 1, the whole operation is repeated.

### INDUSTRIAL APPLICABILITY

The technical solution may be utilised in the compression lubrication of chains of motorcycles, quadricycles and other devices and mechanisms employing a chain drive for quick chain lubrication as required and based on the decision of the driver while the run without stopping and dismounting the motorcycle and subsequent lifting of the motorcycle, by continuously adjustable amount of lubricant in relation to the weather, temperature of the environment, speed of ride, dustiness of the terrain or kilometres driven. The technical solution may also be utilised for the regulation of the lubricant amount supplied onto the motorcycle chain, either to minor chain lubrication, complete lubrication or to wash up the impurities from a stained chain.

What is claimed is:

1. The lubricating device intended for compression chain lubrication characteristic by consisting of a lid (1) with a lid air chamber (11), which is demountably attached to a casing (2) and/or attached via a lid sealing ring (12) onto the upper casing drain (21) of the casing (2), which is demountably attached onto a hollow cylinder (31) with at least one flow opening (311), which is firmly attached onto the lower cap (3) with a cap drain (32) and with at least one cap opening (34), to which a hose connection (41) with an outlet oil hose (4) is demountably attached, and the cap drain (32) is fixed to the casing (2) via a cap sealing ring (33).

2. The lubricating device, according to claim 1, characteristic by the fact that a lower casing drain (22) is formed in the casing (2), in which a lock ring (23) is demountably placed.

3. The lubricating device, according to claim 1, characteristic by the fact that the interior part of the hollow cylinder (31) with flow openings (311) and the upper part of the lower cap (3) constitute an oil chamber (35) with lubrication oil (5), and the exterior part of the hollow cylinder (31) with the flow openings (311), the upper part of the lower cap (3) and the interior part of the casing (2) constitute the casing oil chamber (24) with lubrication oil (5).

4. The operation method of the lubricating device intended for compression chain lubrication characteristic by the fact that by engaging of the lower cap (3) into the casing (2) by the compression air pressure (6) in the lid air chamber (11), the lubrication oil (5) is forced out of the oil chamber (35) and of the casing oil chamber (24) through flow openings (311) and through the cap opening (34) into the oil hose (4).

5. The lubricating device, according to claim 2, characteristic by the fact that the interior part of the hollow cylinder (31) with flow openings (311) and the upper part of the lower cap (3) constitute an oil chamber (35) with lubrication oil (5), and the exterior part of the hollow cylinder (31) with the flow openings (311), the upper part of the lower cap (3) and the interior part of the casing (2) constitute the casing oil chamber (24) with lubrication oil (5).
